(19) United States
(12) Patent Application Publication
(10) Pub. No.: US 2026/0051505 A1
(43) Pub. Date: Feb. 19, 2026

(54) TITANIUM DIOXIDE IN FLOODED DEEP CYCLE LEAD-ACID BATTERIES

(71) Applicant: TROJAN BATTERY COMPANY, LLC, Santa Fe Springs, CA (US)

(72) Inventors: Shawn PENG, Santa Fe Springs, CA (US); Michael VERDE, Santa Fe Springs, CA (US); Jesus PEREZ, Santa Fe Springs, CA (US); Phil SHOLTES, Santa Fe Springs, CA (US)

(73) Assignee: TROJAN BATTERY COMPANY, LLC, Santa Fe Springs, CA (US)

(21) Appl. No.: 19/101,573

(22) PCT Filed: Aug. 8, 2023
(86) PCT No.: PCT/US2023/029677

§ 371 Date: Feb. 5, 2025

Related U.S. Application Data
(60) Provisional application No. 63/370,982, filed on Aug. 10, 2022.

(51) Int. Cl. H01M 4/62; C09D 1/00; C09D 5/24; C09D 7/61; H01M 4/14; H01M 4/38; H01M 10/08

(52) U.S. Cl. CPC H01M 4/628; C09D 1/00; C09D 5/24; C09D 7/61; H01M 4/14; H01M 4/38; H01M 10/08; H01M 2300/0011

(57) ABSTRACT

A flooded deep cycle lead-acid battery includes at least one negative plate, at least one positive plate and an electrolyte. The positive plate comprises a positive electrode grid made primarily of lead and a positive paste including a lead compound and titanium dioxide (TiO₂) additive. A process of manufacturing a positive active material paste for a flooded deep cycle lead-acid battery includes: directly adding TiO2 into a paste mixer with a lead compound to form a mix of positive additives; dry mixing the positive additives to form a dry mixture; adding water to the dry mixture; wet-mixing the water with the dry mixture to form a wet mixture; pasting and curing a positive electrode grid with the wet mixture.

### CROSS REFERENCE TO RELATED APPLICATIONS

This application claims priority to U.S. Provisional Patent Application No. 63/370,982, filed Aug. 10, 2022, entitled “TITANIUM DIOXIDE IN FLOODED DEEP CYCLE LEAD-ACID BATTERIES,” the entirety of which is incorporated by reference herein.

### TECHNICAL FIELD

The present invention relates to enhancing the service life of flooded deep cycle lead-acid batteries. More specifically, this present invention relates to the use of titanium dioxide (TiO₂) in flooded deep cycle lead-acid batteries.

### BACKGROUND OF THE INVENTION

A lead-acid battery is a type of rechargeable battery that includes positive and negative electrodes and an electrolyte. Typical electrodes in a lead-acid battery include an active material paste that is often mounted onto a grid plate. The electrodes also include a separator between them. The grid plates (electrodes) are primarily made of lead but often are combined with antimony, calcium, or tin to form alloys with improved mechanical characteristics. In deep discharge batteries, antimony is generally preferred to form the alloy with lead. The active material pastes typically include lead oxide. The electrolyte usually includes an aqueous acid solution, most often sulfuric acid (H₂SO₄).

To form the battery after assembly, a charge is applied, which converts the lead (Pb), lead oxide (PbO), tri-basic lead sulfate (3PbO·PbSO4·H2O) or tetrabasic lead sulfate (4PbO·PbSO4) of the positive side to lead dioxide (PbO₂) and the lead (Pb), lead oxide (PbO) and tri-basic lead sulfate (3PbO·PbSO4·H2O) of the negative side to lead. In a charged battery, the chemical energy is stored in the lead on the negative electrode and the lead dioxide on the positive electrode, along with the aqueous sulfuric acid. Following formation, a lead-acid battery can be repeatedly discharged and charged. When discharged, the positive and negative electrodes react with the sulfuric acid to form lead (II) sulfate (PbSO₄). A large portion of the sulfuric acid is consumed and becomes primarily water; however, it returns to the aqueous solution when the battery is charged. The chemical reaction that occurs at the negative electrode is as follows:

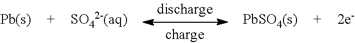

The chemical reaction that occurs at the positive electrode is as follows:

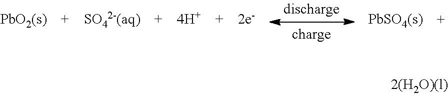

Deep cycle lead-acid batteries differ from lead-acid starter (or high-current) batteries because of their ability to discharge most of their capacity (i.e., have a deep discharge) before needing to be recharged. Deep cycle batteries include thicker electrodes that deliver less peak current than starter batteries but can withstand frequent discharging and are therefore less susceptible to degradation.

Flooded lead-acid batteries are a type of deep cycle lead-acid battery that are also called vented lead-acid batteries or wet cell batteries. Flooded lead-acid batteries have thick, lead-based electrodes that are submerged in an excess of acid electrolyte. This type of battery requires certain maintenance. Some charging conditions may generate hydrogen and oxygen gas, along with the consumption of water in the electrolyte. Therefore, flooded lead-acid batteries need to be vented and have water occasionally added to them. This process may affect the specific gravity of the electrolyte, which must be periodically measured using a hydrometer, and undergo equalization to maintain desired values. Other batteries, such as Valve Regulated Lead Acid (VRLA) batteries, which include Absorbent Glass Mat (AGM) type and gel type batteries, do not require such maintenance, but are generally more expensive than flooded lead-acid batteries and require special chargers.

After a lead-acid battery goes through multiple cycles, a battery may slowly degrade due its normal operation. This degradation may be a result of active material shedding or mossing.

Active material shedding occurs when the bond between the active material and the plate grid weakens, causing a small portion of the active material to fall to the bottom of the battery, thus reducing its overall capacity. The accumulation of active material at the base of a battery will eventually lead to battery failure, either due to the complete shedding of the active material or through the accumulation of the active material at the bottom of the casing, which may bridge to and short with the opposing charged plates within the battery.

Battery mossing occurs when active material builds up on the edges or at the bottom of the electrodes. Mossing occurs at a slow rate but in time may cause a short circuit between the electrodes. Mossing is worsened from overcharging, rough handling, or due to normal motion and vibration when installed in mobile equipment. If a battery is shorted, the battery will be discharged very quickly and will heat up due to the high current flow.

Others have attempted to address lead-acid battery performance and degradation issues by focusing on VRLA-AGM batteries, Lead-Calcium (PbCa) grid alloys and negative plate applications, such as the following publications: Zimáková, J., Vaculík, S., Fryda, D. & Bača, P. Combined Effect of Acryl Fibers and TiO2 in Negative Active Mass of Lead-Acid Accumulator. ECS Trans. 74, 115 (2016); Xiang, J. et al. Beneficial effects of activated carbon additives on the performance of negative lead-acid battery electrode for high-rate partial-state-of-charge operation. Journal of Power Sources 241, 150-158 (2013); and Micka, K. et al. Studies of doped negative valve-regulated lead-acid battery electrodes. Journal of Power Sources 191, 154-158 (2009).

### SUMMARY OF THE INVENTION

The present invention overcomes lead-acid battery performance and degradation issues by adding rutile titanium dioxide (TiO₂) to positive paste, which enhances the positive active material (PAM) life during the cycling of flooded lead-acid batteries that use lead antimony alloy grids.

In some embodiments, the disclosed flooded deep cycle lead-acid battery includes at least one negative plate, at least one positive plate and an electrolyte. The positive plate comprises a positive electrode grid made primarily of lead and a positive paste including a lead compound and TiO₂ additive.

In some embodiments, the TiO₂ additive is rutile TiO₂. In some of these embodiments, the rutile TiO₂ has a particle size less than 10 μm. In some embodiments, the range of weight percent for the rutile TiO₂ is between 0.1% to 4% of oxide load.

In some embodiments, the lead compound comprises lead oxide.

In some embodiments, the positive electrode grid is made of a lead-antimony alloy.

In some embodiments, the electrolyte includes sulfuric acid.

In some embodiments, the positive paste comprises tribasic lead sulfate (3BS) while in other embodiments, the positive paste comprises tetrabasic lead sulfate (4BS). In other embodiments, the positive paste comprises both 3BS and 4BS.

In some embodiments, the disclosed positive plate for a flooded deep cycle lead-acid battery comprises a positive electrode grid made primarily of lead and a positive paste comprising a lead compound and TiO₂ additive.

In some embodiments, the disclosed process of manufacturing a positive active material paste for a flooded deep cycle lead-acid battery includes: directly adding TiO2 into a paste mixer with a lead compound to form a mix of positive additives; dry mixing the positive additives to form a dry mixture; adding water to the dry mixture; wet-mixing the water with the dry mixture to form a wet mixture; pasting and curing a positive electrode grid with the wet mixture.

In some embodiments, the TiO₂ in the disclosed process is rutile TiO₂. In some of these embodiments the rutile TiO₂ has a particle size less than 10 μm. In some embodiments, the range of weight percent for the rutile TiO₂ is between 0.1% to 4% of oxide load.

In some embodiments, the lead compound in the disclosed process comprises lead oxide.

In some embodiments, the positive electrode grid in the disclosed process is made of a lead-antimony alloy.

In some embodiments, the positive paste in the disclosed process comprises 3BS, while in other embodiments the positive paste comprises 4BS. In other embodiments, the positive paste comprises both 3BS and 4BS.

### BRIEF DESCRIPTION OF THE DRAWINGS

Additional properties and advantages of the invention are described below with reference to the accompanying drawings, in which:

FIG. 1 is a schematic sectional view of a flooded deep cycle lead-acid battery according to one embodiment of the present invention;

FIG. 2 compares the crystal structure of rutile TiO2 and β-PbO2.

FIG. 3 is a chart comparing the characteristics of cured positive active material paste where TiO₂ has been added in accordance with some embodiments of the present invention to the characteristics of a cured control positive active material paste where no TiO₂ has been added.

FIG. 4 is a graph comparing the specific discharge capacity of pasted working electrodes according to embodiments of the present invention to control electrodes in which no TiO₂ additives have been added to the positive active material pastes.

FIGS. 5-6 are graphs comparing the cycle life of flooded deep discharge lead-acid batteries according to embodiments of the present invention to control batteries in which no TiO₂ additives have been added to the positive active material pastes.

### DETAILED DESCRIPTION OF THE INVENTION

Identical and functionally equivalent components are usually provided with the same reference numerals in the figures.

The disclosed invention delays the occurrence of positive active material shedding. Additionally, the disclosed invention significantly improves paste skeleton density and porosity, increases positive paste conductivity, and enhances the charging efficiency of the positive plate. Further, the disclosed invention lowers early battery life moss shorts.

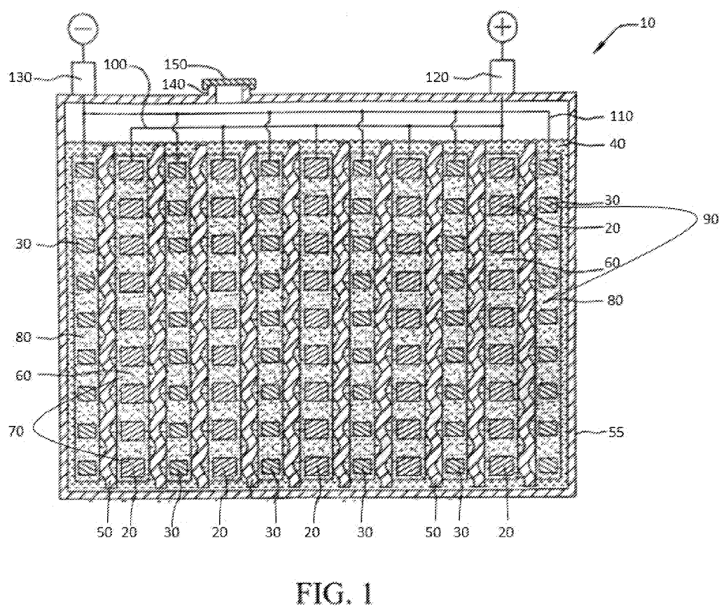

FIG. 1 illustrates one embodiment of the disclosed invention. Flooded deep cycle lead-acid battery 10 includes positive electrode grids 20 and negative electrode grids 30 and electrolyte solution 40. Separators 50 separate the positive electrode grids 20 and negative electrode grids 30 within battery case 55. Positive electrode grids 20 are each coated with positive active material paste 60 to form a positive plate 70. Negative electrode grids 30 are each coated with negative active material paste 80 to form a negative plate 90. The positive electrode grids 20 are connected via a positive current collector 100 and the negative electrode grids 30 are connected via a negative current collector 110. Positive and negative battery terminal posts 120, 130 extend from the battery to provide external electrical contact points for charging and discharging the battery. The battery 10 includes a vent 140 to release excess gas that is produced during charge cycles. A vent cap 150 prevents the electrolyte solution from spilling out of the battery 10. It should be clear to one of ordinary skill in the art that the invention can be applied to both single and multiple cell batteries.

In some embodiments, the electrolyte solution 40 includes an aqueous acid solution. Further, in some embodiments, the electrolyte solution 40 includes sulfuric acid (H₂SO₄).

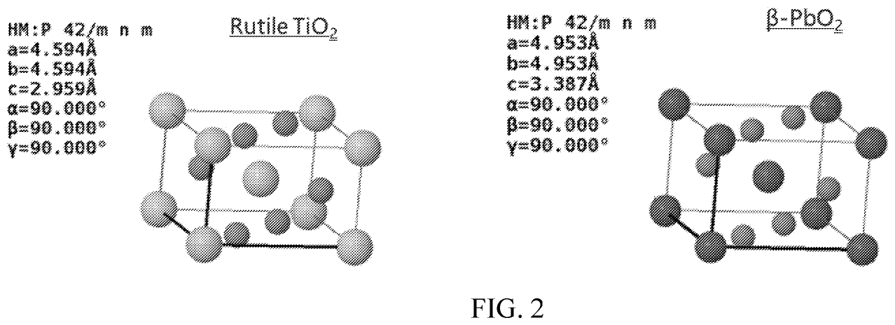

Rutile TiO₂ is one form of TiO₂. Rutile TiO₂ is more stable and has a higher absorption rate than other forms. As shown in FIG. 2, rutile TiO₂ is tetragonal in structure and shares an identical space group to β-PbO2 positive active material.

According to some embodiments, the positive active material paste 60 includes lead oxide and rutile TiO₂. The rutile TiO₂ may have a particle size less than 10 μm. The range of weight percent for the rutile TiO₂ may be between 0.1% to 4% of oxide load.

In accordance with some embodiments, battery 10 with an improved positive plate 70 containing rutile TiO₂ with a weight percent between 0.1% to 4% of oxide load maintains a higher state of charge (SoC) level and includes better charging acceptance than a control battery 10 lacking the rutile TiO₂ additive to the positive active material paste 60.

Additionally, according to some embodiments, battery 10 with an improved positive plate 70 containing rutile TiO₂ with a weight percent between 0.1% to 4% of oxide load maintains a lower positive half-cell potential than a control battery 10 lacking the rutile TiO₂ additive to the positive active material paste 60, which avoids aggressive O₂ gassing and positive grid corrosion.

The paste preparation process for positive plates 70 and negative plates 90 results in particles of definite shape and composition. These particles are spread on the electrode grids 20, 30, cured to interlock the particles into a porous mass, and converted electrochemically into active material to produce the electrode plates 70, 90 of the lead acid battery cell 10. The plates 70, 90 then have an active surface, definite porosity, and a hard active mass and connection to the grid. The porosity of the active materials is determined by the size of the paste particles.

Paste mixing may consist of two stages: dry mixing and wet mixing. The dry mixing mixes the dry lead oxide with positive paste additives or negative paste additives. The lead oxide may be composed of PbO and Pb produced by a ball milling or Barton milling process. The type and amount of additives depends on the specific formula used, which may differ between manufacture and application. After all ingredients have been uniformly mixed, a defined volume of water is added into the mixer to start the wet mixing process. When uniformity has been reached, a certain volume of sulfuric acid, with a defined specific gravity, may be added into the mixer to continue mixing until the final paste-like material has been achieved with a targeted paste density, viscosity, or other required properties. During the whole process, the amount of time spent on each step will be controlled, and peak temperature will be controlled as well.

In some embodiments, the rutile TiO₂ may be added in the paste mixing process. Further, in some embodiments, the rutile TiO₂ may be added into a paste mixer with lead oxide before dry mixing as a positive additive. Water may then be added to the dry mixture and the mixture may be wet-mixed for a certain amount of time. After wet-mixing, acid is added and mixing continues.

The paste 60 may then be placed in a pasting machine, which will press the paste 60 into the electrode grid 20. The paste 60 may be pressed into the empty space around the wires in the electrode grid 20.

In some embodiments, the electrode grids 20 and 30 are primarily made of lead but are combined with antimony.

Once pasted, the electrode grid 20 is referred to as a plate 70. Rollers may flatten the plate 70 surfaces. The plate 70 may then be cured to form an uninterrupted, strong porous mass that is tightly bound to the grid 20. During the curing process, small crystals in the paste may dissolve while big crystals may grow in size. Water between the particles may evaporate, resulting in tribasic lead sulfate (3BS) or tetrabasic lead sulfate (4BS) crystals and PbO particles interconnecting to form a strong skeleton. At curing temperatures above 150° F., 3BS may be converted into 4BS paste.

The curing process may consist of two stages: the wet stage and the drying stage. During the wet stage, the curing chamber will maintain a certain temperature (in some embodiments 105-150° F. with high relative humidity (in some embodiments over 90% and in some embodiments even higher than 95%). The wet curing stage can last from a few hours to tens of hours, depending on the different manufacture processes. The drying stage may be used to fully dry the paste 60 material on the plate 70. This stage may have very low relative humidity (RH) and last from around 10 hours to over 40 hours, depending on plate design and production process design. During the different stages, the paste 60 compositions may change due to an internal reaction, the grid alloy may be oxidized and a corrosion layer (CL) may be established between paste and grid 20 surface. The lead acid battery 10 may then be assembled and formed by applying a charge, which converts the lead oxide of the positive side to PbO₂ and the lead oxide of the negative side to lead.

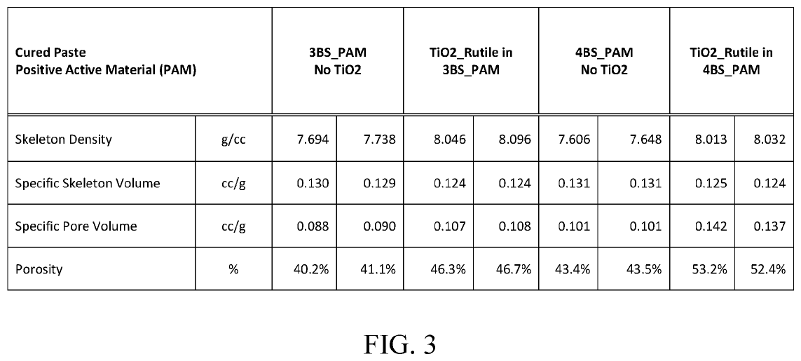

As shown in FIG. 3, control 3BS positive active material paste 60 with no TiO₂ additives has a skeleton density ranging from 7.694 to 7.738 g/cc, while 3BS positive active material paste 60 with 1% TiO₂ additives has a skeleton density ranging from 8.046 to 8.096 g/cc. Similarly, control 4BS positive active material paste 60 with no TiO₂ additives has a skeleton density ranging from 7.606 to 7.648 g/cc, while 4BS positive active material paste 60 with 1% TiO₂ additives has a skeleton density ranging from 8.013 to 8.032 g/cc. TiO₂ additives can therefore increase the positive active material paste 60 skeleton density.

Additionally, as shown in FIG. 3, control 3BS positive active material paste 60 with no TiO₂ additives has a specific skeleton volume ranging from 0.129 cc/g to 0.130 cc/g while 3BS positive active material paste 60 with 1% TiO₂ additives has a specific skeleton volume of 0.124 cc/g. Similarly, control 4BS positive active material paste 60 with no TiO₂ additives has a specific skeleton volume of 0.131 cc/g while 4BS positive active material paste 60 with 1% TiO₂ additives has a specific skeleton volume ranging from 0.124 cc/g to 0.125 cc/g. Further, control 3BS positive active material paste 60 with no TiO₂ additives has a specific pore volume ranging from 0.088 cc/g to 0.090 cc/g while 3BS positive active material paste 60 with 1% TiO₂ additives has a specific pore volume ranging from 0.107 cc/g to 0.108 cc/g. Similarly, control 4BS positive active material paste 60 with no TiO₂ additives has a specific pore volume of 0.101 cc/g while 4BS positive active material paste 60 with 1% TiO₂ additives has a specific pore volume ranging from 0.137 cc/g to 0.142 cc/g.

FIG. 3 also shows the porosity of the positive active material paste 60. As shown in FIG. 3, control 3BS positive active material paste 60 with no TiO₂ additives has a porosity ranging from 40.2% to 41.1% while 3BS positive active material paste 60 with 1% TiO₂ additives has a porosity ranging from 46.3% to 46.7%. Similarly, control 4BS positive active material paste 60 with no TiO₂ additives has a porosity ranging from 43.4% to 43.5% while 4BS positive active material paste 60 with 1% TiO₂ additives has a porosity ranging from 52.4% to 53.2%. TiO₂ additives can therefore increase the porosity of the positive active material paste 60.

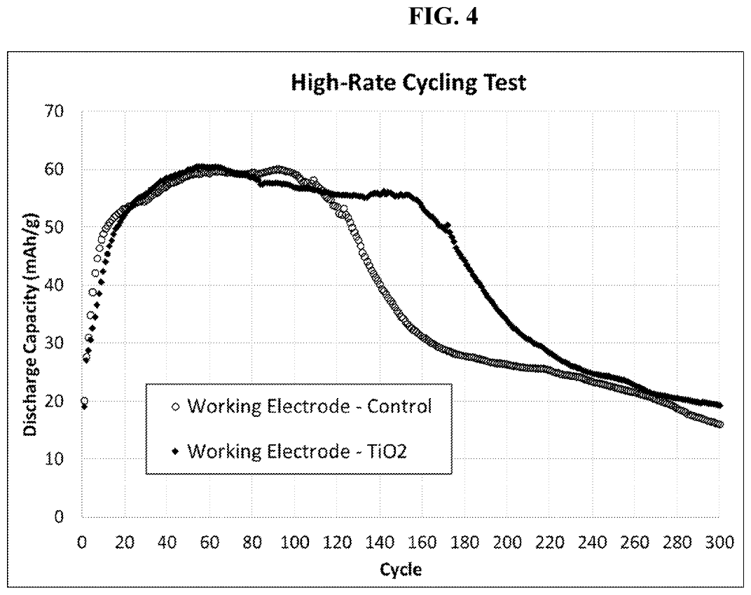

Testing results of batteries in accordance with some embodiments of this invention are shown in FIGS. 4-6. FIG. 4 is a graph of a high-rate cycling test comparing a flooded deep cycle lead-acid electrode containing control positive active material paste with no TiO₂ additives to one containing positive active material paste with 1% rutile TiO₂ additive. FIG. 4 demonstrates that an electrode containing rutile TiO₂ with a weight percent between 0.1% to 4% of oxide load maintains a higher discharge capacity over more cycles than the control, lacking the rutile TiO₂ additive to the positive active material paste.

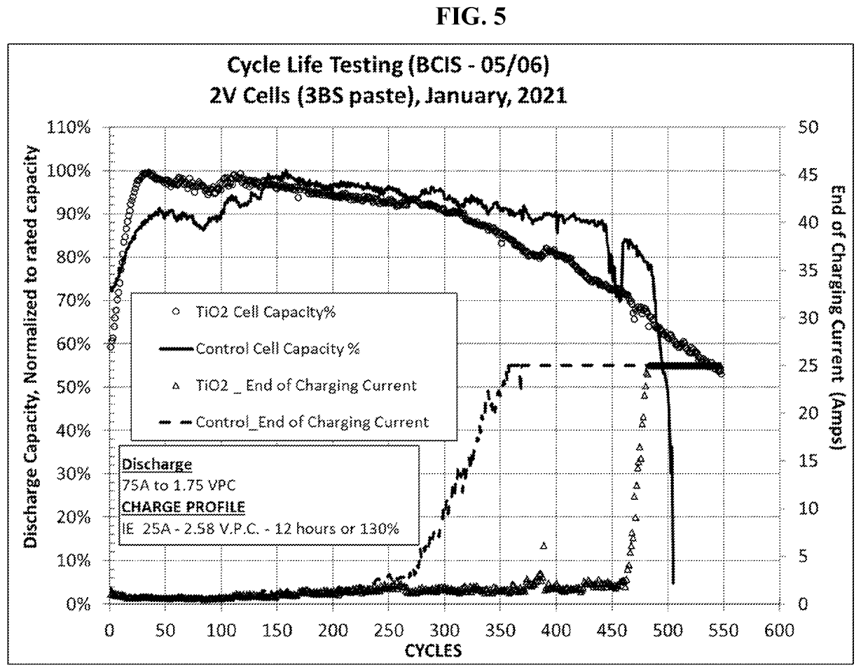

FIG. 5 is a graph of a cycle life test comparing flooded deep cycle lead-acid batteries 10 containing 3BS control positive active material paste 60 with no TiO₂ additives to flooded deep cycle lead-acid batteries 10 containing 3BS positive active material paste 60 with 1% rutile TiO₂ additives. As shown in FIG. 5, there is significant initial capacity improvement in the flooded deep cycle lead-acid batteries 10 containing 3BS positive active material paste 60 with 1% rutile TiO₂ additives. Additionally, there is a clear difference in the antimony suppression effect, which is the suppression of the lead antimony alloy's tendency to leach out of the positive plate 70 and migrate to the negative plate 90 causing a higher end of charging current value (EoCC). The antimony suppression effect is significantly better in the flooded deep cycle lead-acid batteries 10 containing 3BS positive active material paste 60 with 1% rutile TiO₂ additives than the flooded deep cycle lead-acid batteries 10 containing 3BS control positive active material paste 60 with no TiO₂ additives. Further, the cycle life of the flooded deep cycle lead-acid batteries 10 appears to be significantly extended in the flooded deep cycle lead-acid batteries 10 containing 3BS positive active material paste 60 with 1% rutile TiO₂ additives as compared to the flooded deep cycle lead-acid batteries 10 containing 3BS control positive active material paste 60 with no TiO₂ additives.

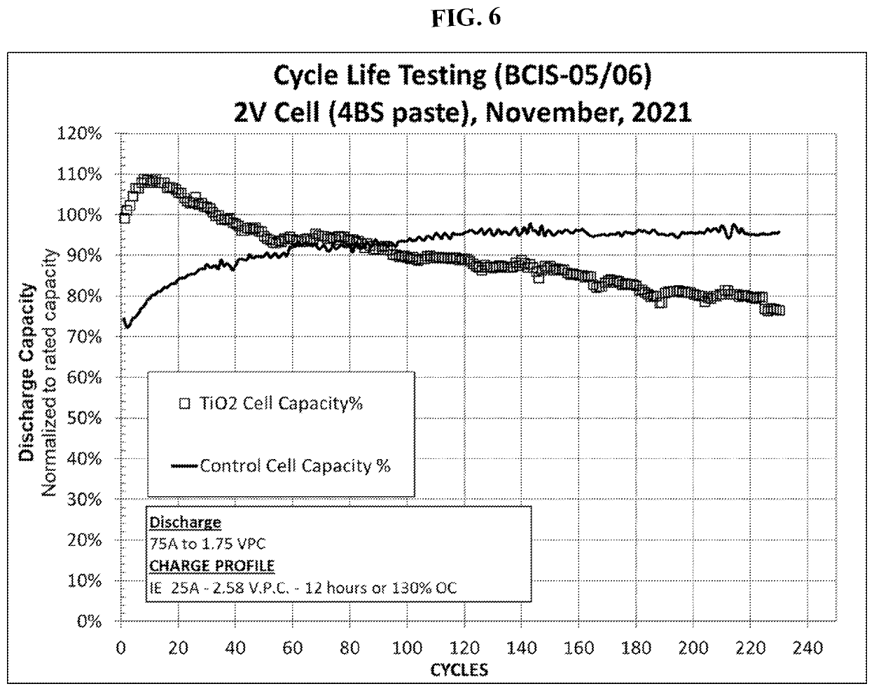

FIG. 6 is a graph of a cycle life test comparing flooded deep cycle lead-acid batteries 10 containing 4BS control positive active material paste 60 with no TiO₂ additives to flooded deep cycle lead-acid batteries 10 containing 4BS positive active material paste 60 with 1% rutile TiO₂ additives. As shown in FIG. 5, there is significant initial capacity and peak capacity improvement in the flooded deep cycle lead-acid batteries 10 containing 4BS positive active material paste 60 with 1% rutile TiO₂ additives.

Although the present invention has been described in terms of exemplary embodiments, it is not limited thereto. Rather, the appended claims should be construed broadly, to include other variants and embodiments of the described embodiments and methods, which may be made by those skilled in the art without departing from the scope and range of equivalents of the present invention.

What is claimed is:

1. A flooded deep cycle lead-acid battery comprising:
at least one negative plate;
at least one positive plate comprising:
a positive electrode grid made primarily of lead; and
a positive paste comprising a lead compound and TiO₂ additive; and
an electrolyte.

2. The battery of claim 1, wherein the TiO₂ additive is rutile TiO₂.

3. The battery of claim 2, wherein the lead compound comprises lead oxide.

4. The battery of claim 1, wherein the positive electrode grid is made of a lead-antimony alloy.

5. The battery of claim 3, wherein the electrolyte includes sulfuric acid.

6. The battery of claim 3, wherein the rutile TiO₂ has a particle size less than 10 μm.

7. The battery of claim 3, wherein the range of weight percent for the rutile TiO₂ is between 0.1% to 4% of oxide load.

8. The battery of claim 3, wherein the positive paste comprises tribasic lead sulfate (3BS).

9. The battery of claim 3, wherein the positive paste comprises tetrabasic lead sulfate (4BS).

10. The battery of claim 3, wherein the positive paste comprises both tribasic lead sulfate (3BS) and tetrabasic lead sulfate (4BS).

11. A positive plate for a flooded deep cycle lead-acid battery comprising:
a positive electrode grid made primarily of lead; and
a positive paste comprising a lead compound and TiO₂ additive.

12. The positive plate of claim 11, wherein the TiO₂ additive is rutile TiO₂.

13. The positive plate of claim 12, wherein the lead compound comprises lead oxide.

14. The positive plate of claim 13, wherein the positive electrode grid is made of a lead-antimony alloy.

15. The positive plate of claim 13, wherein the rutile TiO₂ has a particle size less than 10 μm.

16. The positive plate of claim 13, wherein the range of weight percent for the rutile TiO₂ is between 0.1% to 4% of oxide load.

17. The positive plate of claim 13, wherein the positive paste comprises tribasic lead sulfate (3BS).

18. The positive plate of claim 13, wherein the positive paste comprises tetrabasic lead sulfate (4BS).

19. The positive plate of claim 13, wherein the positive paste comprises tribasic lead sulfate (3BS) and tetrabasic lead sulfate (4BS).

20. A process of manufacturing a positive active material paste for a flooded deep cycle lead-acid battery comprising:
directly adding TiO₂ into a paste mixer with a lead compound to form a mix of positive additives;
dry mixing the positive additives to form a dry mixture;
adding water to the dry mixture;
wet-mixing the water with the dry mixture to form a wet mixture;
pasting and curing a positive electrode grid with the wet mixture.

21. The process of claim 20, wherein the TiO₂ is rutile TiO₂.

22. The process of claim 21, wherein the lead compound comprises lead oxide.

23. The process of claim 20, wherein the positive electrode grid is made of a lead-antimony alloy.

24. The process of claim 22, wherein the rutile TiO₂ has a particle size less than 10 μm.

25. The process of claim 22, wherein the range of weight percent for the rutile TiO₂ is between 0.1% to 4% of oxide load.

26. The process of claim 22, wherein the positive paste comprises tribasic lead sulfate (3BS).

27. The process of claim 22, wherein the positive paste comprises tetrabasic lead sulfate (4BS).

28. The process of claim 22, wherein the positive paste comprises both tribasic lead sulfate (3BS) and tetrabasic lead sulfate (4BS).
